(19) United States
(12) Patent Application Publication
(10) Pub. No.: US 2016/0088484 A1
(43) Pub. Date: Mar. 24, 2016

(54) SPECTRUM COORDINATION DEVICES, RADIO COMMUNICATION DEVICES, SPECTRUM COORDINATION METHODS, AND METHODS FOR CONTROLLING A RADIO COMMUNICATION DEVICE

(71) Applicant: AGENCY FOR SCIENCE, TECHNOLOGY AND RESEARCH, Connexis, Singapore (SG)

(72) Inventors: Daiqin YANG, Singapore (SG); Sen GOPA, Singapore (SG); Shoukang ZHENG, Singapore (SG); Ser Wah OH, Singapore (SG)

(73) Assignee: AGENCY FOR SCIENCE, TECHNOLOGY AND RESEARCH, Singapore (SG)

(21) Appl. No.: 14/780,729

(22) PCT Filed: Mar. 28, 2014
(86) PCT No.: PCT/SG2014/000146

§ 371 Date: Sep. 28, 2015

Related U.S. Application Data
(60) Provisional application No. 61/805,983, filed on Mar. 28, 2013.

(51) Int. Cl. H04W 16/14; H04W 24/08

(52) U.S. Cl. CPC H04W 16/14; H04W 24/08

(57) ABSTRACT

According to various embodiments, a spectrum coordination device may be provided. The spectrum coordination device may include: a memory configured to store working channel information indicating for each radio communication device of a plurality of radio communication devices information of at least one channel used by the respective radio communication device; a radio communication device information receiver configured to receive working channel update information of at least one radio communication device of the plurality of radio communication devices; a conflict determination circuit configured to determine whether there is a conflict of channels to be used by the plurality of radio communication devices based on the working channel information and the working channel update information; and a working channel information updating circuit configured to update the working channel information based on the determination of the conflict determination circuit.

### CROSS-REFERENCE TO RELATED APPLICATIONS

The present application claims the benefit of the U.S. provisional patent application No. 61/805,983 filed on 28 Mar. 2013, the entire contents of which are incorporated herein by reference for all purposes.

### TECHNICAL FIELD

Embodiments relate generally to spectrum coordination devices, radio communication devices, spectrum coordination methods, and methods for controlling a radio communication device.

### BACKGROUND

Coordinated spectrum access may be important for radio systems to enable spectrum sharing among co-located systems. It may assign different working frequencies for different sub-systems for the sake of interference mitigation as well as spectrum reuse. The problem of coordinated spectrum access has been extensively studied in cellular systems. However, unlike cellular systems which monopolize their whole radio bands, radio systems working on shared radio bands may resolve both competitions among its own sub-systems and competitions from external co-existing systems. Thus, there may be a need for an efficient coordinated spectrum access for radio systems working on shared radio bands.

### SUMMARY

According to various embodiments, a spectrum coordination device may be provided. The spectrum coordination device may include: a memory configured to store working channel information indicating for each radio communication device of a plurality of radio communication devices information of at least one channel used by the respective radio communication device; a radio communication device information receiver configured to receive working channel update information of at least one radio communication device of the plurality of radio communication devices; a conflict determination circuit configured to determine whether there is a conflict of channels to be used by the plurality of radio communication devices based on the working channel information and the working channel update information; and a working channel information updating circuit configured to update the working channel information based on the determination of the conflict determination circuit.

According to various embodiments, a radio communication device may be provided. The radio communication device may include: a channel information receiver configured to receive a channel occupation list; a channel quality measurement circuit configured to measure for a plurality of channels a communication quality; and a channel selection circuit configured to select a channel for communication based on the channel occupation list and the measured communication quality for the plurality of channels.

According to various embodiments, a spectrum coordination method may be provided. The spectrum coordination method may include: storing working channel information indicating for each radio communication device of a plurality of radio communication devices information of at least one channel used by the respective radio communication device; receiving working channel update information of at least one radio communication device of the plurality of radio communication devices; determining whether there is a conflict of channels to be used by the plurality of radio communication devices based on the working channel information and the working channel update information; and updating the working channel information based on the determining whether there is a conflict.

According to various embodiments, a method for controlling a radio communication device may be provided. The method for controlling a radio communication device may include: receiving a channel occupation list; measuring for a plurality of channels a communication quality; and selecting a channel for communication based on the channel occupation list and the measured communication quality for the plurality of channels.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a system architecture according to various embodiments;

FIG. 2A shows spectrum coordination device in accordance with an embodiment;

FIG. 2B shows spectrum coordination device in accordance with an embodiment;

FIG. 2C shows radio communication device in accordance with an embodiment;

FIG. 2D shows radio communication device in accordance with an embodiment;

FIG. 2E shows flow diagram illustrating a spectrum coordination method in accordance with an embodiment;

FIG. 2F shows flow diagram illustrating a method for controlling a radio communication device in accordance with an embodiment;

FIG. 3 shows an information diagram of a centralized spectrum coordinator according to various embodiments;

FIG. 4 shows an information diagram of distributed TV WS devices according to various embodiments;

FIG. 5 shows a flow diagram illustrating a signaling procedure of ticket-based managed spectrum access according to various embodiments;

FIG. 6 shows a flow diagram illustrating spectrum management signaling according to various embodiments;

FIG. 7A and 7B show flow diagrams illustrating processing flows of distributed devices according to various embodiments; and

FIG. 8A and 8B show flow diagrams illustrating processing flows of spectrum coordinator according to various embodiments.

### DESCRIPTION

Embodiments described below in context of the devices are analogously valid for the respective methods, and vice versa. Furthermore, it will be understood that the embodiments described below may be combined, for example, a part of one embodiment may be combined with a part of another embodiment.

In this context, the spectrum coordination device as described in this description may include a memory which is for example used in the processing carried out in the spectrum coordination device. In this context, the radio communication device as described in this description may include a memory which is for example used in the processing carried out in the radio communication device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

Various embodiments relate to coordinated dynamic spectrum access for radio systems working on shared radio bands.

Coordinated spectrum access may be important for radio systems to enable spectrum sharing among co-located systems. It may assign different working frequencies for different sub-systems for the sake of interference mitigation as well as spectrum reuse. The problem of coordinated spectrum access has been extensively studied in cellular systems. However, unlike cellular systems which monopolize their whole radio bands, radio systems working on shared radio bands may resolve both competitions among its own sub-systems and competitions from external co-existing systems.

TVWS (television white space) is a newly emerging radio technology that may work on the terrestrial TV (television) bands as an unlicensed secondary user as long as it does not interfere with those licensed primary users such as TV sets or microphones. It will be understood that although TVWS is described herein as an example application domain for the coordinated dynamic spectrum access mechanism, nevertheless the various embodiments described may be applicable for all radio systems working on shared radio bands.

To guarantee the privilege of primary users on the terrestrial TV bands, TVWS secondary devices may periodically query a central geo-location database to get the available channel list on which they can work. The available channel list may be calculated by authorized databases based on the location of the TVWS secondary device and a pre-specified radio attenuation model. The available channel list may vary with the time schedule of the primary users.

The coordinated dynamic spectrum access mechanism according to various embodiments may be provided for large scale systems with multiple distributed TVWS secondary devices. It may addresses the following challenges:

1) Internal interference among distributed devices: In large scale wireless systems, there may be internal interferences among distributed devices if the working channel of each device were not properly allocated. Although such internal interferences may be detected by distributed devices and eliminated by subsequent spectrum management procedures, the cost of spectrum management procedures, including channel measurement and channel switch, may be expensive. Moreover, frequent channel switch and measurement may render the system unstable and may result in unnecessary performance fluctuations.

2) Localized and unpredictable interference from external co-existing entities: TVWS radio bands may be openly accessible to all kinds of unlicensed TVWS secondary users as long as the primary users are properly protected. The available channel list provided by the geo-location database may only inform about the presence of nearby primary users. Interference from external contending TVWS secondary devices may be desired to be detected locally by TVWS devices. With location dependent and time-varying external interferences, the signaling cost may be prohibitively high to maintain a centralized interference map about distributed devices for centralized dynamic channel assignment.

3) Computational complexity of optimized solution: As in cellular networks, a centralized channel assignment mechanism may be used to settle unnecessary internal interferences among sub-systems. However, the complexity of centralized channel assignment may be much higher for large scale TVWS radio systems than in cellular systems. First of all, the time varying interferences from external devices may make it impossible to apply static frequency allocations as in cellular networks. Besides, the diversified available channel list among_distributed TVWS secondary devices may make the already NP-complete problem even more tedious to get the optimized solution for spectrum allocation.

To address the above-mentioned problems for radio system on shared radio bands, a coordinated dynamic spectrum access mechanism may be provided according to - various embodiments. It may be a combination of centralized as well as distributed solutions, in which a central coordinator may be used to provide limited level of coordination while the channel selection decision may be made locally by distributed TVWS devices.

The spectrum access mechanism according to various embodiments may eliminate internal interferences among contending TVWS devices within the same system and may adapt to the time-varying available channel list and external interferences with limited computational complexity.

Fully distributed spectrum sharing may not require additional infrastructure and is thus attractive for its cost effectiveness. A fully distributed inter-access point coordination protocol may be used for dynamic channel selection of co-located WLANs (wireless local area network). The network may be organized in an autonomous way in which all the APs (access points) are peer entities. Channel selection phases may be initiated by an initiator and participated by peer responders conforming to a negotiation mechanism. Conventionally, a distributed coordination mechanism may approximate the behavior of centralized situations. Devices which interfere locally may optionally be grouped into coordination groups. Although it exhibits a superior simulation performance in achieving fairness of spectrum allocation, the coordination protocol may involve a time consuming and complicated iterative phase to reach the optimized spectrum assignment.

A further conventional dynamic spectrum access protocol (DSAP) may handle the spectrum sharing issue with centralized servers which take charge of both information collection and channel assignment for distributed clients. The major difference between the devices and methods according to various embodiments and DSAP is that DSAP focuses on the negotiation mechanism of working channel assignment while the devices and methods according to various embodiments focus on radio information collection and distribution. With DSAP, channel occupation status may be known only to the server for centralized channel selection while according to various embodiments, the channel occupation status may be shared and synchronized with distributed devices such that they can make their local channel selections. Although distributed devices in DSAP may make suggestions about their desired working channel, the final channel selection is made by the server. It may thus take a long negotiation phase before a working channel agreement can be reached by the client and the server if the information about local channel interference and noise conditions is not fresh enough at the server side.

Although the invention is illustrated and described in the following paragraphs with reference to various embodiments, the invention is not intended to be limited to the details shown. Modifications may be made in the details within the scope and range equivalents of the claims and without departing from the invention.

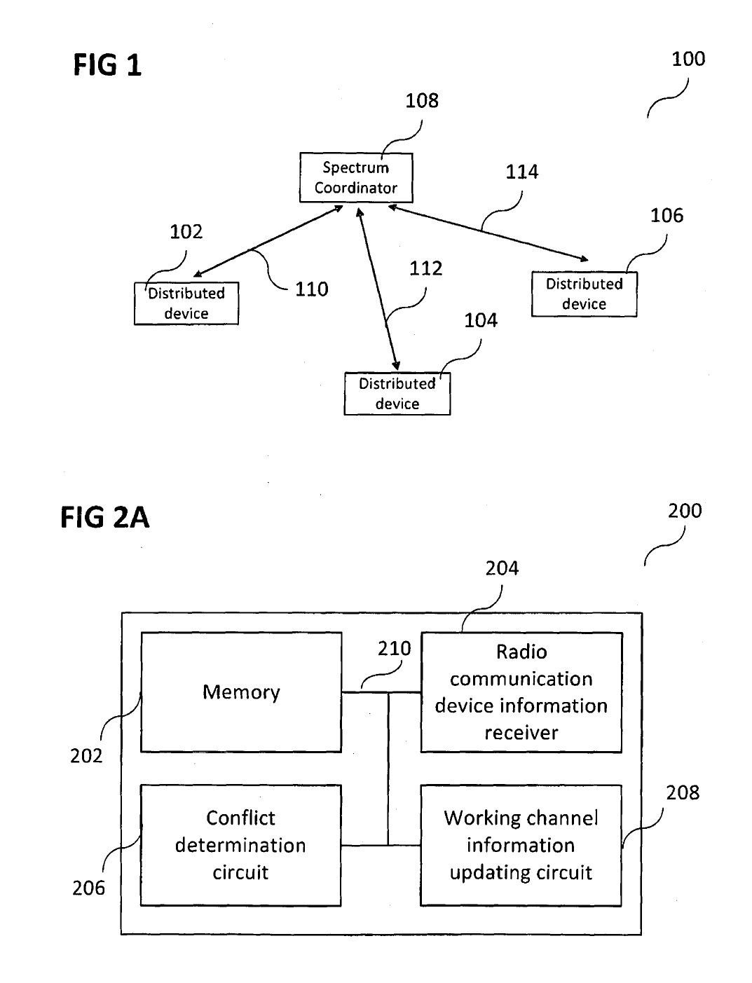

FIG. 1 shows a system architecture 100 according to various embodiments. The coordinated dynamic spectrum access mechanism according to various embodiments is built on-top of a centralized architecture as shown in FIG. 1. Each distributed TVWS device 102, 104, 106 may be connected to a centralized spectrum coordinator 108, for example using radio communication, like illustrated by arrows 110, 112, 114. It will be understood that although three distributed device 102, 104, 106 are illustrated in FIG. 1, any number of distributed devices may be present. The channel selection decisions may be made locally by distributed devices 102, 104, 106 while the central coordinator 108 may help them to avoid unnecessary internal interferences among each other. Each distributed device may serve as a local access point for a group of slave devices (not shown in FIG. 1) while it is not necessary for the spectrum coordinator 108 to know the existence of those slave devices.

According to various embodiments, an efficient coordinated spectrum access for radio systems working on shared radio bands may be provided.

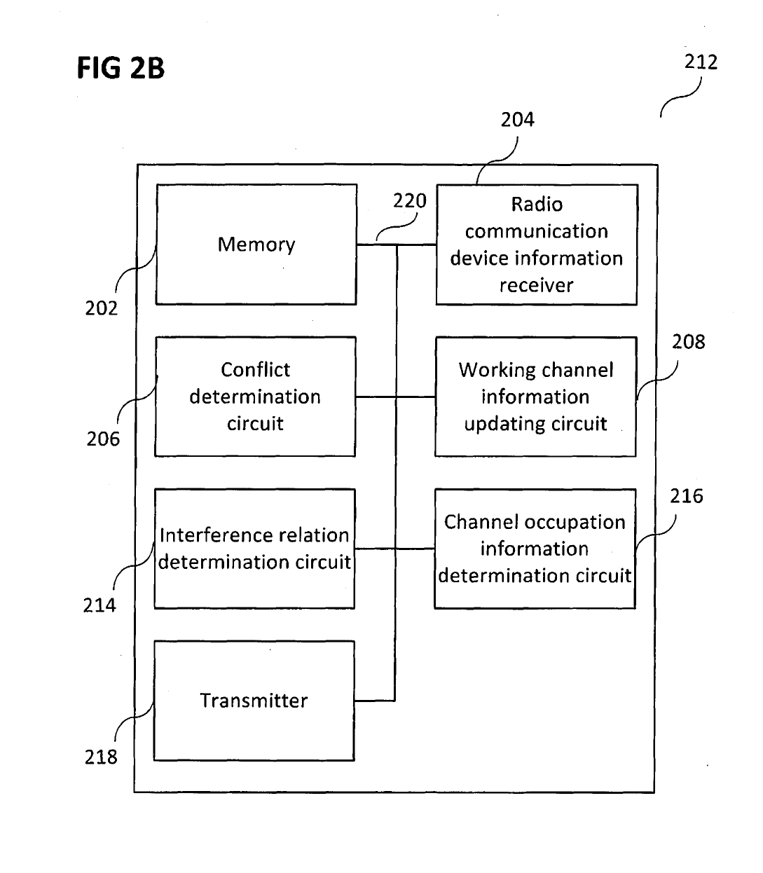

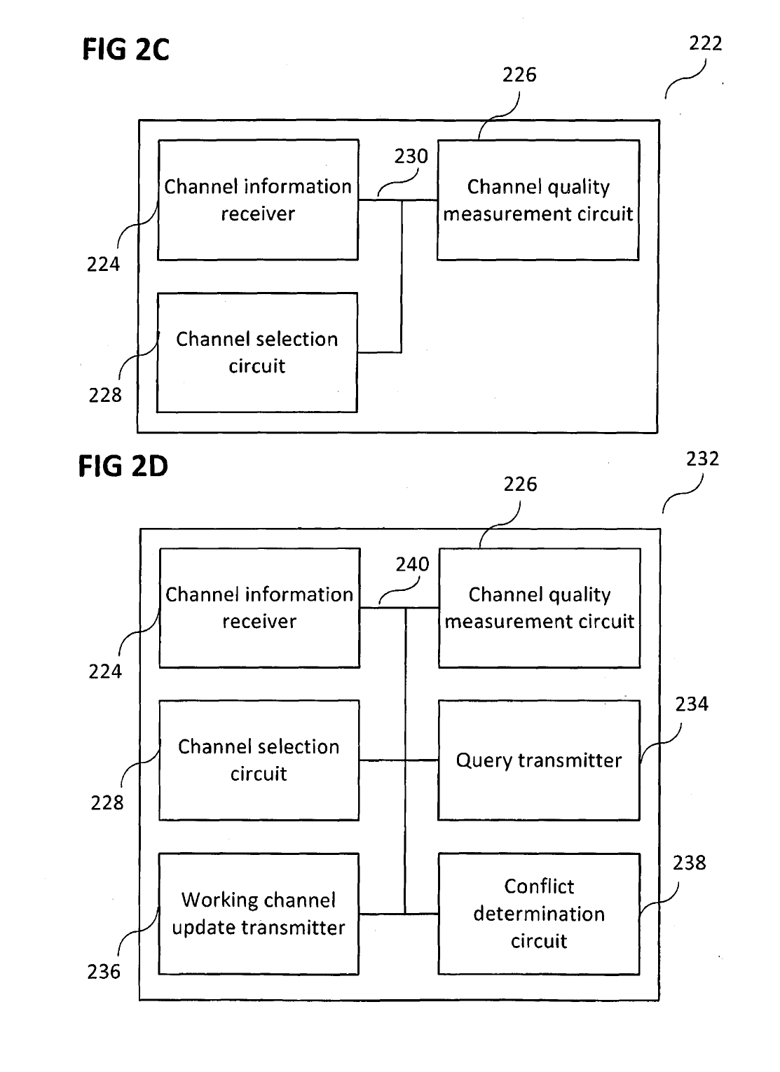

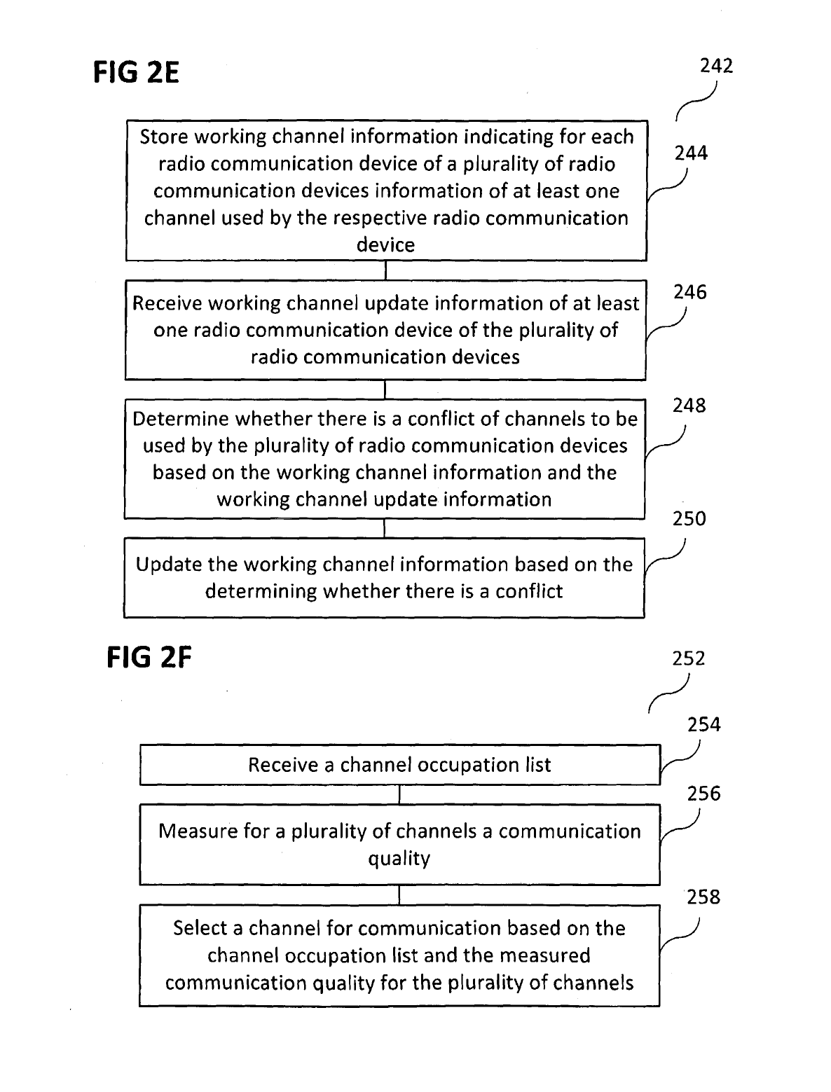

FIG. 2A shows a spectrum coordination device 200 in accordance with an embodiment. The spectrum coordination device 200 may include a memory 202 configured to store working channel information indicating for each radio communication device of a plurality of radio communication devices information of at least one channel used by the respective radio communication device. The spectrum coordination device 200 may further include a radio communication device information receiver 204 configured to receive working channel update information of at least one radio communication device of the plurality of radio communication devices. The spectrum coordination device 200 may further include a conflict determination circuit 206 configured to determine whether there is a conflict of channels to be used by the plurality of radio communication devices based on the working channel information and the working channel update information. The spectrum coordination device 200 may further include a working channel information updating circuit 208 configured to update the working channel information based on the determination of the conflict determination circuit 206. The memory 202, the radio communication device information receiver 204, the conflict determination circuit 206, and the working channel information updating circuit 208 may be coupled with each other, like indicated by lines 210, for example electrically coupled, for example using a line or a cable, and/ or mechanically coupled.

In other words, the spectrum coordination device 200 may determine whether a newly reported channel that is intended to be used by a radio communication device (or that has already been started to be used by the radio communication device) causes interference or any other kind of conflict with other channels or the same channel used by other radio communication devices.

It will be understood that a working channel of (or for) a radio communication device is a channel that is (or may be) used by the radio communication device, for example for communication.

According to various embodiments, the radio communication device information receiver 204 may further be configured to receive location information of at least one radio communication device of the plurality of radio communication devices.

FIG. 2B shows spectrum coordination device 212 in accordance with an embodiment. The spectrum coordination device 212 may, similar to the spectrum coordination device 200 shown in FIG. 2A, include a memory 202 configured to store working channel information indicating for each radio communication device of a plurality of radio communication devices information of at least one channel used by the respective radio communication device. The spectrum coordination device 212 may, similar to the spectrum coordination device 200 shown in FIG. 2A, further include a radio communication device information receiver 204 configured to receive working channel update information of at least one radio communication device of the plurality of radio communication devices. The spectrum coordination device 212 may, similar to the spectrum coordination device 200 shown in FIG. 2A, further include a conflict determination circuit 206 configured to determine whether there is a conflict of channels to be used by the plurality of radio communication devices based on the working channel information and the working channel update information. The spectrum coordination device 212 may, similar to the spectrum coordination device 200 shown in FIG. 2A, further include a working channel information updating circuit 208 configured to update the working channel information based on the determination of the conflict determination circuit 206. The spectrum coordination device 212 may further include an interference relation determination circuit 214, like will be described in more detail below. The spectrum coordination device 212 may further include a channel occupation information determination circuit 216, like will be described in more detail below. The spectrum coordination device 212 may further include a transmitter 218, like will be described in more detail below. The memory 202, the radio communication device information receiver 204, the conflict determination circuit 206, the working channel information updating circuit 208, the interference relation determination circuit 214, the channel occupation information determination circuit 216, and the transmitter 218 may be coupled with each other, like indicated by lines 220, for example electrically coupled, for example using a line or a cable, and/ or mechanically coupled.

According to various embodiments, the interference relation determination circuit 214 may be configured to determine an interference for a plurality of channels based on the location information.

According to various embodiments, the interference relation determination circuit 214 may further be configured to determine the interference for the plurality of channels further based on a radio propagation model.

According to various embodiments, the channel occupation information determination circuit 216 may be configured to determine channel occupation information indicating for each radio communication device of the plurality of radio communication devices at least one of a load and a maximum transmission power for at least one channel.

According to various embodiments, the transmitter 218 may be configured to transmit to each radio communication device of the plurality of radio communication devices the channel occupation list.

According to various embodiments, the working channel information updating circuit 208 may be configured to set the channels of a radio communication device that is to re-select new channels to a pre-determined value.

According to various embodiments, the radio communication devices may be TV WS devices.

FIG. 2C shows radio communication device 222 in accordance with an embodiment. The radio communication device 222 may include a channel information receiver 224 configured to receive (for example from a spectrum coordination device as described with reference to FIG. 2A or FIG. 2B) a channel occupation list. The radio communication device 222 may further include a channel quality measurement circuit 226 configured to measure for a plurality of channels a communication quality. The radio communication device 222 may further include a channel selection circuit 228 configured to select a channel for communication based on the channel occupation list and the measured communication quality for the plurality of channels. The channel information receiver 224, the channel quality measurement circuit 226, and the channel selection circuit 228 may be coupled with each other, like indicated by lines 230, for example electrically coupled, for example using a line or a cable, and/ or mechanically coupled.

In other words, the radio communication device 222 may select a channel based on measurements and furthermore based on a channel occupation list received.

According to various embodiments, the channel information receiver 224 may further be configured to receive an available channel list.

FIG. 2D shows radio communication device 232 in accordance with an embodiment. The radio communication device 232 may, similar to the radio communication device 222 shown in FIG. 2C, include a channel information receiver 224 configured to receive (for example from a spectrum coordination device as described with reference to FIG. 2A or FIG. 2B) a channel occupation list. The radio communication device 232 may, similar to the radio communication device 222 shown in FIG. 2C, further include a channel quality measurement circuit 226 configured to measure for a plurality of channels a communication quality. The radio communication device 232 may, similar to the radio communication device 222 shown in FIG. 2C, further include a channel selection circuit 228 configured to select a channel for communication based on the channel occupation list and the measured communication quality for the plurality of channels. The radio communication device 232 may further include a query transmitter 234, like will be described in more detail below. The radio communication device 232 may further include a working channel update transmitter 236, like will be described in more detail below. It will be understood that although the query transmitter 234 and the working channel update transmitter 236 are shown as separate transmitters in FIG. 2D, they may be provided as a single (in other words: combined) transmitter. The radio communication device 232 may further include a conflict determination circuit 238, like will be described in more detail below. The channel information receiver 224, the channel quality measurement circuit 226, the channel selection circuit 228, the query transmitter 234, the working channel update transmitter 236, and the conflict determination circuit 238 may be coupled with each other, like indicated by lines 240, for example electrically coupled, for example using a line or a cable, and/or mechanically coupled.

According to various embodiments, the query transmitter 234 may be configured to transmit a query for a channel occupation list.

According to various embodiments, the working channel update transmitter 236 may be configured to transmit a working channel update.

According to various embodiments, the conflict determination circuit 238 may be configured to determine whether there is a conflict of a channel to be used by the radio communication device with channels used by at least one other radio communication device.

According to various embodiments, the radio communication device 226 may be configured to change a channel to be used by the radio communication device 226 if it is determined that there is a conflict.

According to various embodiments, the radio communication device 226 may be a TVWS device.

FIG. 2E shows flow diagram 242 illustrating a spectrum coordination method in accordance with an embodiment. In 244, working channel information indicating for each radio communication device of a plurality of radio communication devices information of at least one channel used by the respective radio communication device may be stored. In 246, working channel update information of at least one radio communication device of the plurality of radio communication devices may be received. In 248, it may be determined whether there is a conflict of channels to be used by the plurality of radio communication devices based on the working channel information and the working channel update information. In 250, the working channel information may be updated based on the determining whether there is a conflict.

According to various embodiments, the spectrum coordination method may further include receiving location information of at least one radio communication device of the plurality of radio communication devices.

According to various embodiments, the spectrum coordination method may further include determining an interference for a plurality of channels based on the location information.

According to various embodiments, the spectrum coordination method may further include determining the interference for the plurality of channels further based on a radio propagation model.

According to various embodiments, the spectrum coordination method may further include determining channel occupation information indicating for each radio communication device of the plurality of radio communication devices at least one of a load and a maximum transmission power for at least one channel.

According to various embodiments, the spectrum coordination method may further include transmitting to each radio communication device of the plurality of radio communication devices the channel occupation list.

According to various embodiments, the spectrum coordination method may further include setting the channels of a radio communication device that is to re-select new channels to a pre-determined value.

According to various embodiments, the radio communication devices may be TVWS devices.

FIG. 2F shows flow diagram 252 illustrating a method for controlling a radio communication device in accordance with an embodiment. In 254, a channel occupation list may be received. In 256, for a plurality of channels a communication quality may be measured. In 258, a channel for communication may be selected based on the channel occupation list and the measured communication quality for the plurality of channels.

According to various embodiments, the method may further include receiving an available channel list.

According to various embodiments, the method may further include transmitting a query for a channel occupation list.

According to various embodiments, the method may further include transmitting a working channel update.

According to various embodiments, the method may further include determining whether there is a conflict of a channel to be used by the radio communication device with channels used by at least one other radio communication device.

According to various embodiments, the method may further include changing a channel to be used by the radio communication device if it is determined that there is a conflict.

According to various embodiments, the radio communication device may be a TVWS device.

In the following, the centralized spectrum coordinator will be described in more detail.

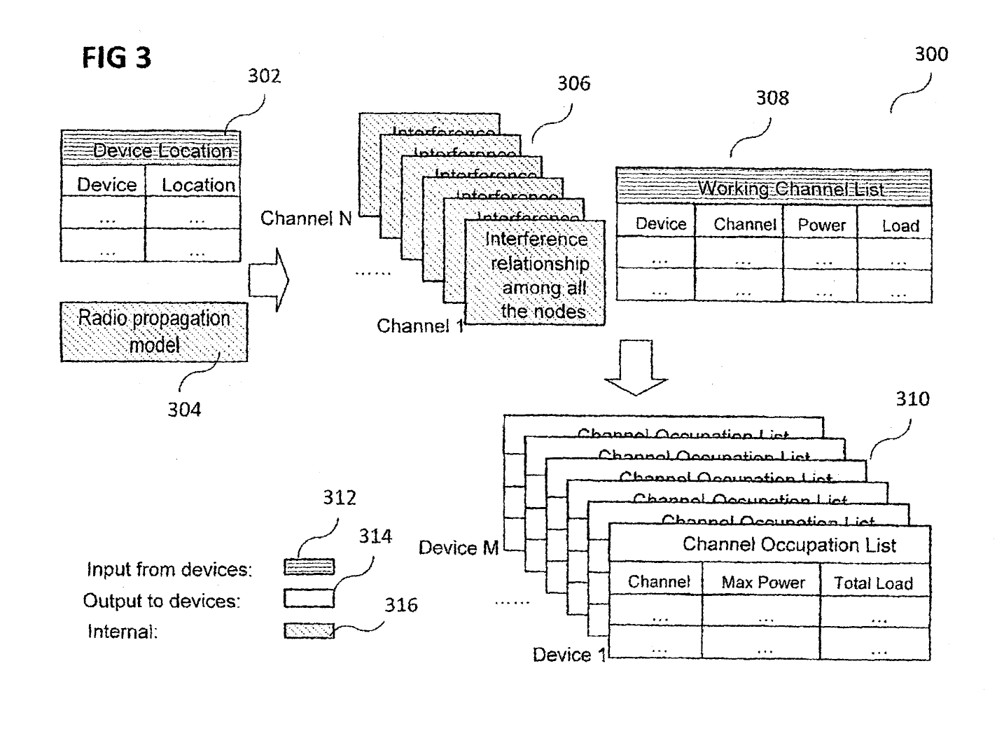

FIG. 3 shows an information diagram 300 of a centralized spectrum coordinator according to various embodiments. Information which is input from the (distributed) devices is illustrated with horizontal lines in the header, like shown in 312. Information which is output to the (distributed) devices is illustrated without lines in the header, like shown in 314. Internal information is illustrated with diagonal lines in the header, like shown in 316. The spectrum coordinator may maintain a device location list 302 to record the exact location of all the distributed devices in the system. With a chosen radio propagation model 304, interference relationship 306 among distributed devices may be calculated for each channel and stored in the spectrum coordinator. For different channels with different central frequencies, the interference relationship among distributed devices may be different. These per channel interference relationships may be re-calculated whenever there is a location change to any one of the distributed devices. The spectrum coordinator also maintains a working channel list 308, recording the channel each distributed device is currently working on and the transmission power as well as the traffic load it uses. This working channel list may be maintained by the central controller to be always updated.

With the working channel list 308 and the pre-calculated per-channel interference relationship 306, the spectrum coordinator may calculate a channel occupation list 310 for each distributed device. The channel occupation list 310 of a certain device may depict the channel usage of other contending (distributed) devices within its local vicinity and implies the availability of channel usage while regarding the internal interferences. The interference relationship 306 may be defined according to the capability of distributed devices as well as the required control granularity of various applications. If distributed devices can adjust their transmission power according to application requirements, the interference relationship may be defined as the received interference power level at one (distributed) device given the other (distributed) device is transmitting with a unit power level. With this kind of interference relationship, the maximum allowable transmitting power (MaxPower) field in the channel occupation list may be calculated with a commonly defined acceptable noise floor power level and the known transmission powers of all the devices. The detailed information diagram of the central controller may be as depicted in FIG. 3. If the transmit power of each device is pre-specified and fixed, the interference relationship may be defined as ON/OFF flags, indicating the media contention relationship among distributed devices. In such cases, the maximum allowable transmission power field in the channel occupation list may be replaced by an ON/OFF flag, indicating the whether the channel can be used or not.

In addition to the MaxPower field, a TotalLoad field may be included in the channel occupation lists 310 that may be distributed to individual (distributed) devices. This field may be designed for at least two different scenarios. A first scenario may be when there is no vacant channel available for certain (distributed) devices to make their channel selection. In such cases, the (distributed) device may be able to access the wireless media and make use of some unused fractions of occupied channels according to certain media access mechanisms, such as for example CSMA/CA (carrier sense multiple access with collision avoidance). This TotalLoad field may then be used by distributed devices as an indicator to select the most suitable channel to share its traffic load with other contending (distributed) devices. Another scenario may be when there are multiple vacant channels available. In this case, the field may be used by the central coordinator to indicate different priorities to different channels and in turn affect the channel selection behavior of distributed devices.

In the following, the distributed devices according to various embodiments will be described in more detail.

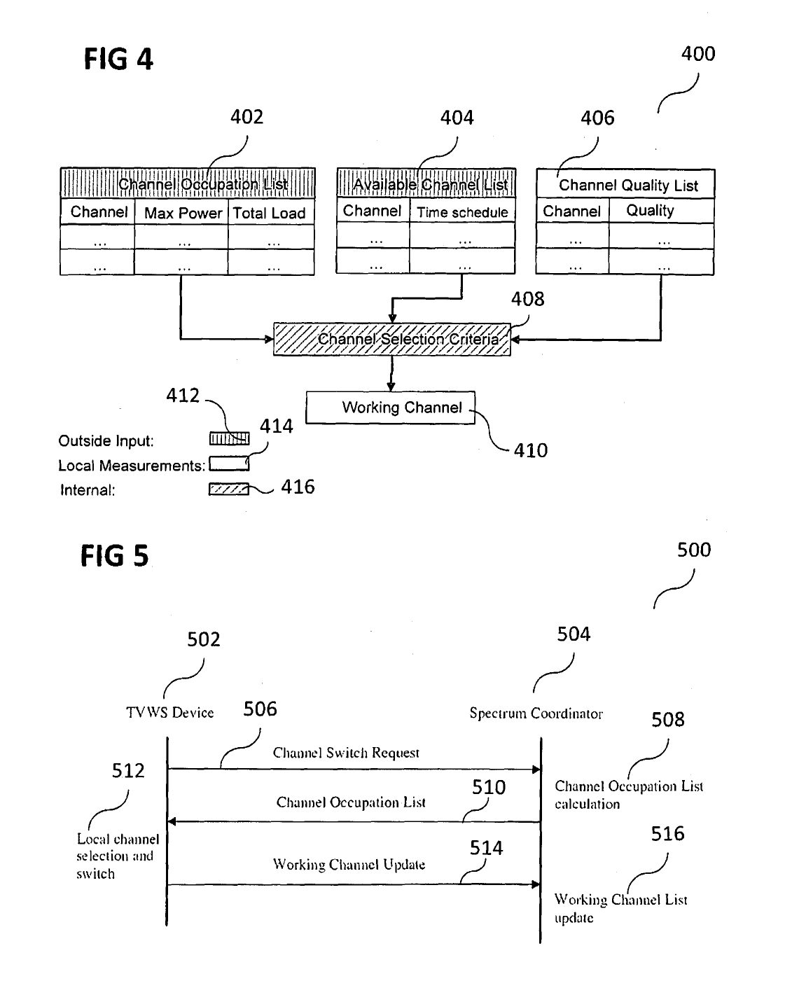

FIG. 4 shows an information diagram 400 of distributed devices, for example distributed TVWS devices, according to various embodiments. Information which is input from the outside (for example from a central coordinator, for example from the (centralized) spectrum coordinator or from a geo-location database) is illustrated with vertical lines in the header, like shown in 412. Information which is based on local measurements in the distributed device is illustrated without lines in the header, like shown in 414. Internal information is illustrated with diagonal lines in the header, like shown in 416. Inside each distributed device, there may be three different channel tables used for its local decision on channel selection. The first table may be an available channel list 404 that may constrain the candidate channels on which it can work on. For TVWS devices, the available channel list 404 may be periodically refreshed from a geo-location database. In other application domains, this available channel list 404 may be maintained from other external entities or even a simple pre-specified static channel list. Besides this available channel list 404, each distributed device may also maintain a channel quality list 406, which may record its local measurement about the quality of all the available channels. The method about how to measure the quality of channels may be one or more of a plurality of commonly used methods. The third table may be the channel occupation list 402, which may come from the central coordinator. The detailed information diagram of distributed devices is depicted in FIG. 4.

The three different channel lists 402, 404, 406 may be used by distributed devices represent different categories of interference entities. For TVWS devices, the available channel list 404 may indicate the interferences with primary users. The channel occupation list 402 may indicate the potential interference with peer devices within the same system, and the channel quality list 406 may depict media contentions from the external entities. The channel selection decision may be made according to the three channel lists 402, 404, 406 to avoid interference with all these three different categories of contending entities. Selection criteria 408 may be provided to determine a working channel 410 based on the three channel lists 402, 404, 406, and a person skilled in the art would know various ways of how to determine such selection criteria 408.

In the following, signaling procedures according to various embodiments will be described.

As the channel selection and switch decisions may be made locally by the distributed devices, it may be important to keep the channel occupation lists always updated in the distributed devices for those unpredictable channel switches triggered by local request. Information may be exchanged between distributed devices and the spectrum coordinator. According to various embodiments, a ticket-based managed spectrum access signaling scheme and/or a periodical update based autonomous spectrum access signaling scheme may be provided.

In the following, ticket-based managed spectrum access signaling according to various embodiments will be described.

FIG. 5 shows a flow diagram 500 illustrating a signaling procedure of ticket-based managed spectrum access according to various embodiments. Communication between a TVWS device 502 and a spectrum coordinator 504, and corresponding processing are shown.

With ticket-based spectrum access signaling scheme, although the channel selection and switch decisions are made locally by the distributed devices, a ticket may be requested by the distributed devices before they can select and switch to a new working channel. On receiving a channel switch request 506 from a distributed device together with the requested transmit power, the spectrum coordinator checks whether there are other contending devices currently holding channel switch tickets. If there are no such devices, the channel switch request may be granted. A newly calculated (for example calculated as illustrated in 508) channel occupation list may be sent to the distributed device together with the ticket in 510. If there are other contending devices currently on their channel selection and switch phase, the request may be ignored.

If the channel switch request times out without any ticket being granted, the requesting device may wait for a time period before it tries again. If the channel switch request is granted with a ticket sent by the spectrum coordinator, the requesting device may select a new working channel according to the latest channel occupation list, which is attached with the ticket, as well as the other two channel lists. On finishing the local channel selection and switch in 512, the ticket may be returned to the spectrum coordinator by sending the working channel update message 514, indicating the current working channel, the transmission power, and the estimated traffic load the device uses. The spectrum coordinator may then update its working channel list accordingly in 516.

It is to be noted that multiple channel switch tickets may be granted by the central coordinator at the same time as long as all the ticket holders will not interfere with each other in all the possible channels. If the central coordinator keeps a copy of the available channel list of each individual device, it may be sufficient to check only those candidate channels on the intersection set of the available channel lists of the requesting device and other ticket holding devices. Otherwise, all the channels may be checked for potential interferences among concurrent ticket holding devices. The signaling procedure of ticket based spectrum access is shown in FIG. 5.

With ticket-base spectrum management, concurrent conflicting channel switch of distributed devices may be coordinated to be in sequence. This may effectively improve the consistence of the working channel list at the central coordinator and avoid system fluctuations caused by conflicting channel switches. However, this signaling mechanism may rely heavily on the central coordinator and may render the system vulnerable to single point of failures. According to various embodiments, another periodical update based autonomous spectrum access scheme may be provided. With this scheme, upon unexpected failure of the central coordinator, the performance of the system may be gracefully downgraded to the level of normal distributed spectrum management system.

In the following, periodical update based autonomous spectrum management signaling according to various embodiments will be described.

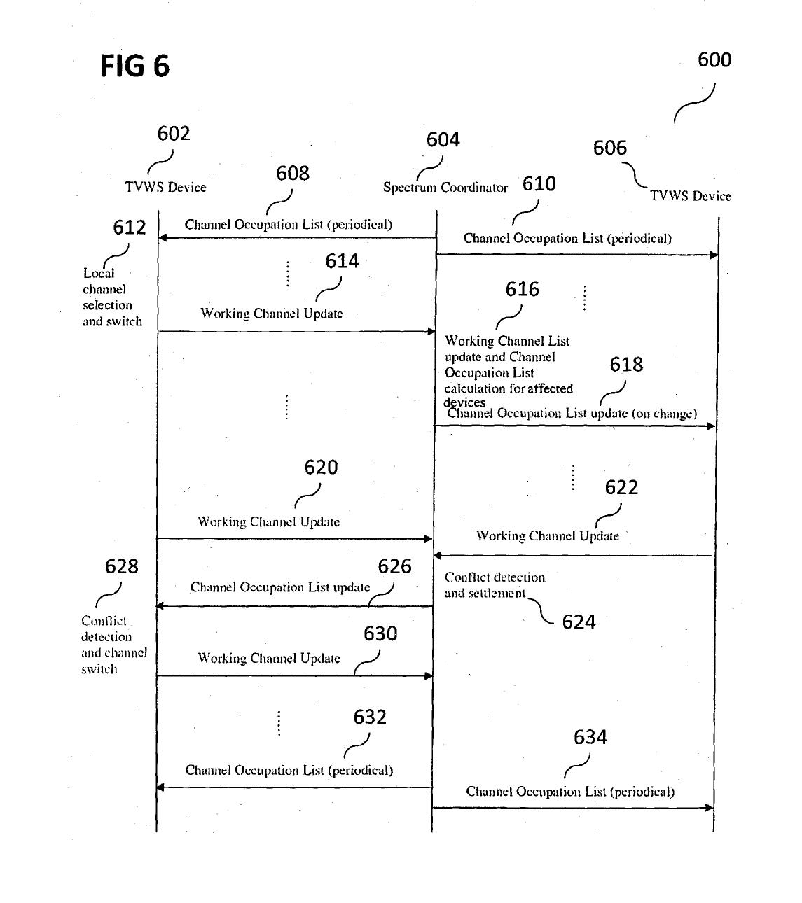

FIG. 6 shows a flow diagram 600 illustrating spectrum management signaling according to various embodiments. Communication between a first TVWS device 602, a spectrum coordinator 604, and second TVWS device 606, and corresponding processing are shown. It will be understood that although communication and processing for two TVWS devices 602, 604 is shown, any number of TVWS devices (or generally distributed devices) may be present.

With periodical update based spectrum access, the spectrum coordinator 604 may send a refreshed channel occupation list to each distributed device 602, 604 periodically, for example in 608, 610, 632, and 634. Each distributed device may directly select and switch to a new working channel according to its local information. It does not need to inquire the central coordinator 604 for channel switch permissions. There are two issues related with this periodical update mechanism. One is the synchronization of the channel occupation list at distributed devices. The other is the possibility of concurrent conflicting channel switches of multiple (distributed) devices.

To guarantee that each device has a refreshed channel occupation list when it undertakes the channel selection and switch phase, devices may send working channel updates to the central coordinator whenever they change their working channels. For example, after the first TV WS device 602 performs a local channel selection and switch in 612, it may send a working channel update 614 to the spectrum coordinator 604. Upon receiving a working channel update from a distributed device, the central coordinator 604 may update its working channel list and may calculate the channel occupation list accordingly, for example in 616, for example for the affected devices (in other words: for the devices affected by the received working channel update). After the working channel list is updated, the central coordinator 604 may find all the devices that would have an updated channel occupation list and may push the updated channel occupation lists to all those affected devices, for example in 618.

When conflicting working channel updates are received by the central coordinator due to concurrent channel switches (for example like illustrated in 620 and 622), the coordinator 604 may resolve the confliction, for example in 624, by selectively reject the current working channel of certain devices. To reject the working channel of certain devices, the working channels of those devices may be set to NULL in the working channel list. A channel occupation list may be sent to those devices indicating the occupancy of their current working channels by other contending devices (for example as shown in 626). On receiving an updated channel occupation list, each distributed device may check whether his current working channel is occupied by other contending devices, for example like shown in 628. If a confliction is detected, a new channel selection and switch phase may be triggered, and a working channel update 630 may be sent accordingly. An example of the signaling procedure is shown in FIG. 6.

It is to be noted here that if the central coordinator 604 knows the available channel list of each device, this signaling scheme may be easily adopted for centralized channel assignment. The spectrum coordinator may send a purposely modified channel occupation list with all the other channels been marked as occupied while leave only the to-be-assigned channel as un-occupied. In this way, a distributed device may automatically adjust their working channel to the assigned one.

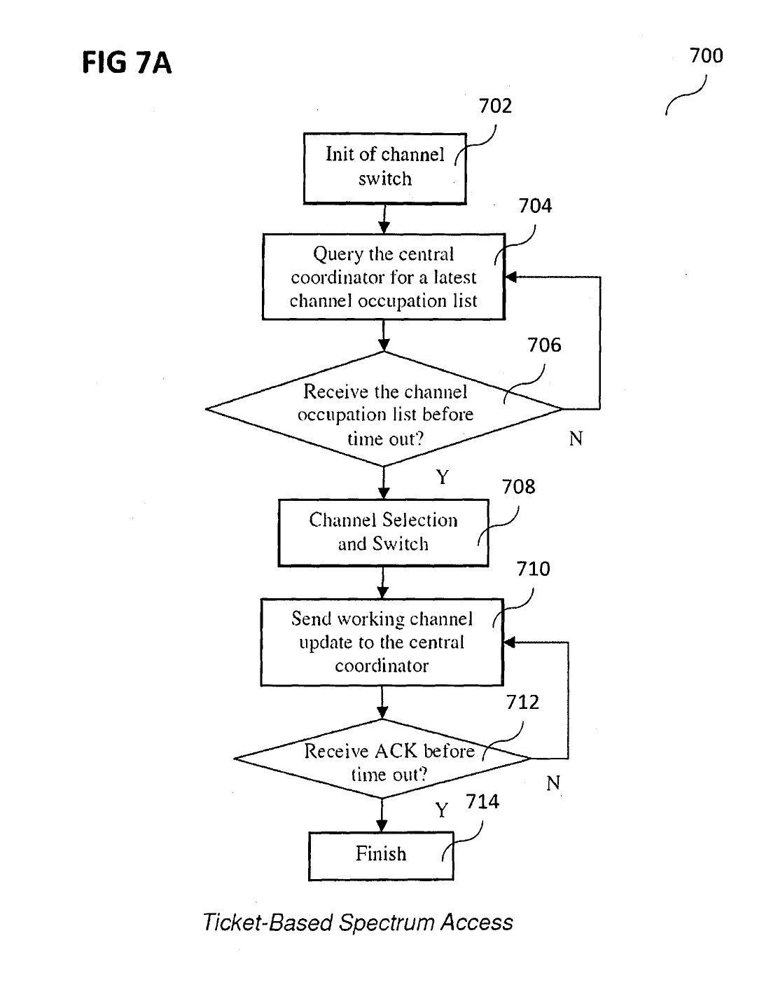

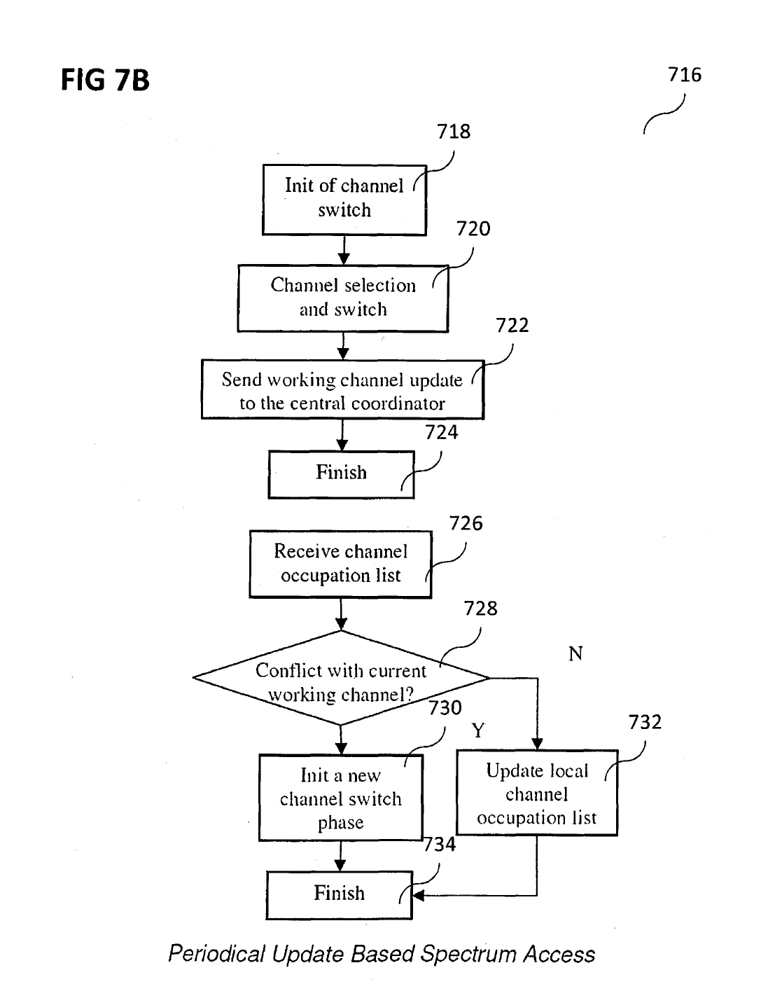

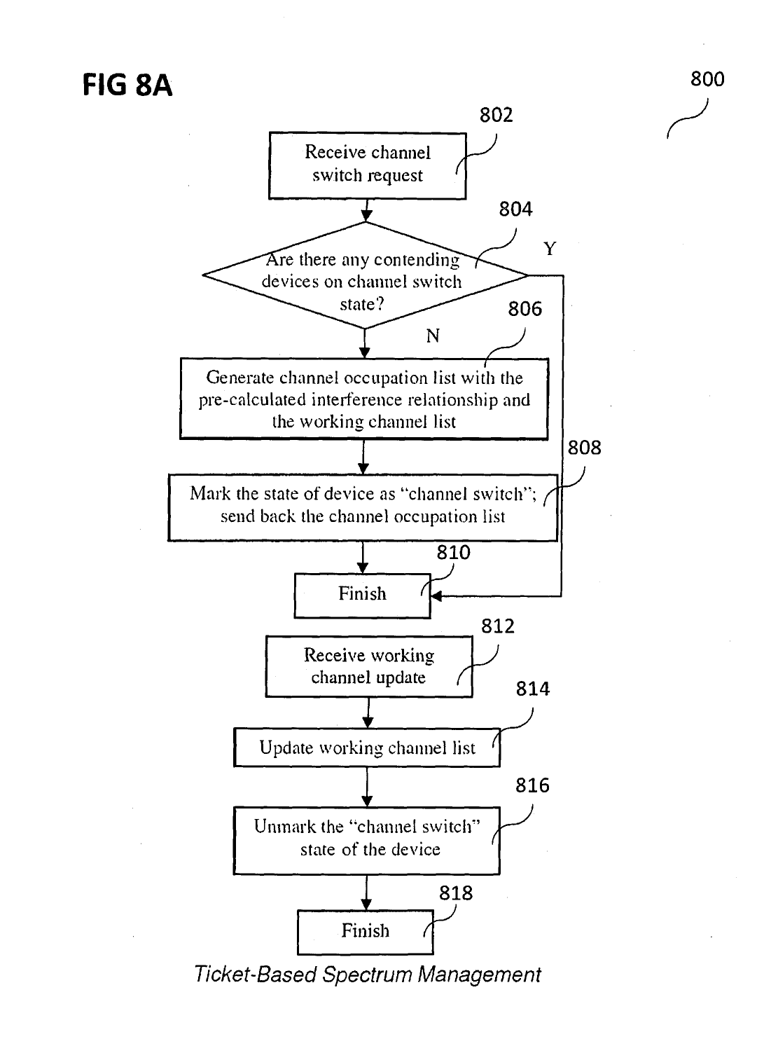

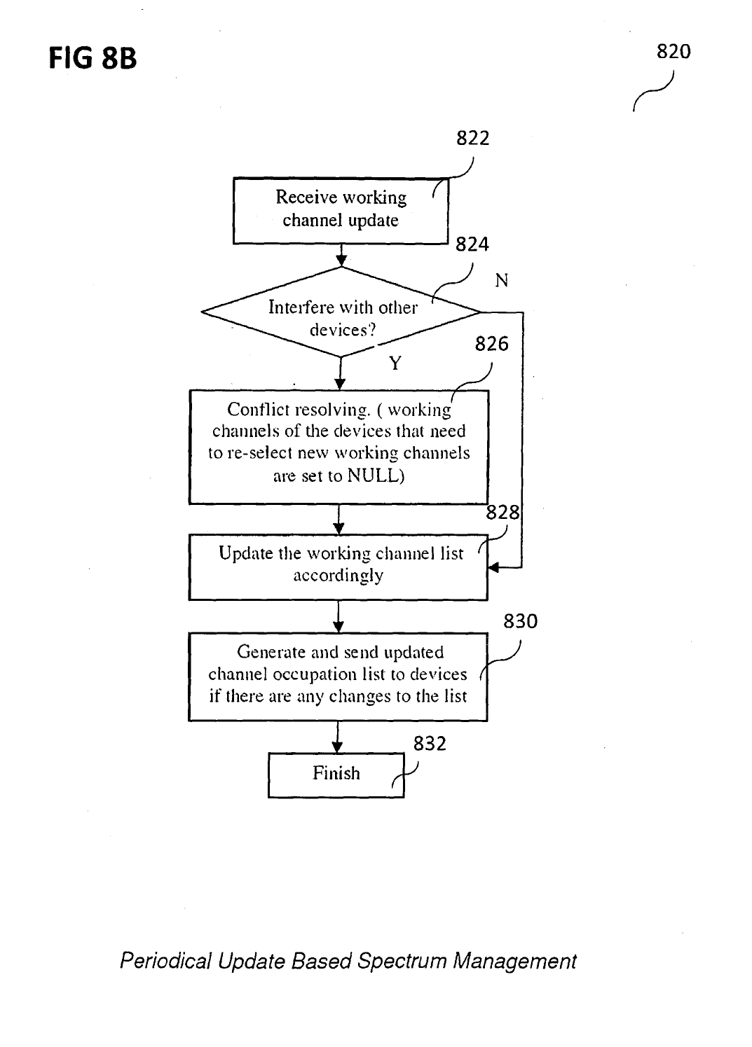

The processing flow of distributed devices and the central coordinator for the two different signaling mechanisms are depicted in FIGS. 7A, 7B, 8A, and 8B respectively.

FIG. 7A shows a flow diagram 700 illustrating a processing flow of a distributed device for ticket-based spectrum access.

In 702, a channel switch may be initiated. In 704, the central coordinator may be queried for to latest channel occupation list. In 706, it may be determined whether the channel occupation list is received before a time out. If it is determined that the channel occupation list is not received before a time out, processing may return to 704. If it is determined that the channel occupation list is received before a time out, processing may proceed in 708, where a channel selection and switch may be performed. In 710, a working channel updated may be sent to the central coordinator. In 712, it may be determined whether an acknowledgement (ACK) is received before a time out. If it is determined that an acknowledgement (ACK) is not received before a time out, processing may return to 710. If it is determined that an acknowledgement (ACK) is received before a time out, processing may finish in 714.

FIG. 7B shows a flow diagram 716 illustrating a processing flow of a distributed device for periodic update based spectrum access. In 718, a channel switch may be initiated. In 720, a channel selection and switch may be performed. In 722, a working channel update may be sent to the central coordinator. Processing may finish in 724. Furthermore, in 726, a channel occupation list may be received. In 728, it may be determined whether there is a conflict with the current working channel. If it is determined that there is a conflict with the current working channel, processing may proceed in 730, where a new channel switch phase may be initiated. If it is determined that there is no conflict with the current working channel, processing may proceed in 732, where the local channel occupation list may be updated. Processing may finish in 734.

FIG. 8A shows a flow diagram 800 illustrating a processing flow of the spectrum coordinator for ticket-based spectrum access. In 802, a channel switch request may be received. In 804, it may be determined whether there are any contending devices on channel switch state. If it is determined that there is at least one contending device on channel switch state, processing may finish in 810. If it is determined that there are no contending devices on channel switch state, processing may proceed in 806, where a channel occupation list may be generated with the pre-calculated interference relationship and the working channel list. In 808, the state of the device (for example the device from which the channel switch request is received) may be marked as “channel switch”, and the channel occupation list may be sent back. Processing may end in 810. Furthermore, in 812, a working channel update may be received. In 814, the working channel list may be updated. In 816, the “channel switch” state of the may be unmarked. Processing may finish in 818.

FIG. 8B shows a flow diagram 820 illustrating a processing flow of the spectrum coordinator for periodic update based spectrum access. In 822, a working channel updated may be received. In 824, it may be determined whether there is interference with other devices. If it determined that there is interference with other devices, processing may proceed in 826, where conflict resolving may be performed, for example by setting the working channels of the devices that need to re-select new working channels to NULL, and processing may further proceed in 828. If it is determined in 824 that there is no interference with other devices, processing may proceed in 828, where the working channel list is updated accordingly. In 830, an updated channel occupation list may be generated and sent to the devices if there are any changes to the list. Processing may finish in 832.

Since the information may be exchanged between distributed devices and the spectrum coordinator through the channels/frequency bands that are occupied by primary users, a concentrator could operate as the master mode by selecting a channel itself based on the list e.g. provided by the TV bands database or determined by spectrum sensing decision and initiate a network by broadcasting enabling signals (e.g. beacons) to other devices. To this end, the distributed devices may listen to the enabling signals, either by sequentially scanning all the channels or following a pre-defined sequence (e.g. fixed, generated sequence by a known algorithm or dynamically updated sequence) to scan the channels, provided that the coordinator fixes one free channel to send out the enabling signals once this channel is in the available list. The former may take a longer time for the distributed devices to detect the presence of the coordinator while the latter could shorten the latency to find out the available channel for signaling between the coordinator and the distributed devices if some prior information is utilized. According to various embodiments, the methods to detect the presence of the signaling channel may be as follows:
The sequentially scanning may be done in a certain order without pre-negotiation, either with a fixed pattern or randomly. However, the sequence may be determined by distributed device without pre-arrangement.

The pre-defined sequence may be stored beforehand in the device. In this method, the sequence may be fixed regardless of the channel availabilities, or generated with a given algorithm that is known to both the coordinator and the distributed devices.
The sequence may be dynamically changed and updated to the distributed device through the broadcast by the coordinator in regular intervals (during the transmission of enabling signals). The sequence change may be based on the querying results from geo-location database access, spectrum sensing decision and/or other appropriate approaches used to determine the availability of the channels. If the available channel list is changed in the update interval, the coordinator may skip/discard the channel with the status change. When there is no change of the list, the coordinator may follow the sequence as stated in the enabling signals explicitly or implicitly. The implicit method may be used to infer the signaling channel.

According to various embodiments, the central coordinator may work in similar ways as the TVWS systems' geo-location database for coordinated interference avoidance. The geo-location database may send back available channel list to secondary devices to resolve the contentions between primary users and secondary users, while the central coordinator may send back channel occupation list to distributed devices to resolve contentions among peer devices. The major difference between them lies in the following three aspects.

A first difference is the real-time maintenance of working channel list. With geo-location database, primary users may register the change of their working channel with the database at least two days in advance. It is thus adequate for distributed TVWS secondary users to query the database on a daily basis for the channel occupation status of primary users. However, in wireless systems of multiple distributed devices, it may be almost impossible for such pre-schedule based channel allocation with the existence of unpredictable interferences from external competitors. It may thus either be the case that each distributed device may query the central controller for the most updated channel occupation list right before their channel switches, or communication sockets may be maintained inside each distributed devices to receive the latest channel occupation list pushed by the central coordinator.

A second difference between geo-location database and the central coordinator may be the pre-calculated contention relationship in the central coordinator. Although the geo-location database knows the location of all the primary users, the available channel list may only be calculated at the time the query is received with the location of the querying device. However, in wireless systems of multiple distributed devices, the interference relationship between those distributed users may be pre-calculated and stored inside the central coordinator for the ease of processing. When there are any changes to the working channel list, updated channel occupation lists may be easily calculated based on the interference relationship.

A third difference is the signaling procedure. With periodical update mechanism, the central coordinator may actively send the most updated channel occupation list to distributed devices, while in TVWS system, the geo-location database only waits passively for queries to distribute the available channel list to TVWS secondary devices. With ticket based mechanism, the central coordinator may record and maintain a list of devices currently undergoing the channel switch phase, and based on this list to admit or reject new channel switch requests. In TVWS system, the geo-location database does not maintain such list to guarantee sequential channel switches among contending devices.

According to various embodiments, at least the following advantages may be provided:
Internal interferences among peer devices may be eliminated with coordinated channel access. This may increase the stability of systems and may eliminate performance fluctuations due to unnecessary channel switches with internal interferences.
Distributed devices may adapt quickly to the time-varying external interferences with limited computational complexity.
The workload of spectrum sensing for both primary users and secondary users may be reduced to the channel occupation list, which may be a subset of the available channel list.

According to various embodiments, a method of coordinated dynamic spectrum access may be provided for large scale radio systems including multiple distributed devices, which may include of two different entities: Distributed devices which may select their own working channels independently based on various information input, and a central spectrum coordinator which may coordinate the channel selection behavior of distributed devices by maintaining and distributing internal contention status.

According to various embodiments, the method may include:
Signaling between the central spectrum coordinator and the distributed devices, whereby the spectrum coordinator may send a channel occupation list (or channel occupation lists) to the distributed device and the distributed devices in turn may update their own working channel information to the spectrum coordinator;
The spectrum coordinator may maintain updated information on the device location list as well as working channel list of all the distributed devices based on the received signaling information; it may also maintain interference relationship among nodes using the device location list and a radio propagation model;
The spectrum coordinator may generate the channel occupation list based on the working channel list and the interference relationship among the nodes;
A distributed device may select its own working channel using three different channel tables; it may use the channel occupation list received from the central spectrum coordinator, available channel list refreshed from geo-location database and channel quality list that is recorded from the local measurement;
The distributed device may switch to a newly selected channel using a signaling procedure defined between the spectrum coordinator and the distributed device.

The signaling step described above may define different procedures for channel switching by the distributed devices. For example, the procedures may include:
Ticket based spectrum access signaling where the channel switch is done by the distributed device on receiving approval from the spectrum coordinator, thus avoiding any conflicting channel switch.
Periodical update based autonomous spectrum management signaling where a distributed device may directly select and switch to a new channel based on local information and then update its channel information to the spectrum coordinator. The spectrum coordinator may subsequently resolve any channel conflict by signaling to the concerned device.

Periodic update based signaling may also address the situation of unexpected failure of the central coordinator, whereby the performance of the system may be gracefully downgraded to the level as normal distributed spectrum management system.

According to various embodiments, methods to detect the channel selected by the coordinator to facilitate the signaling between the coordinator and the distributed devices may be provided. The approaches may give the sequence of the channels that the distributed device will use to detect the presence of coordinator signaling.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A spectrum coordination device comprising:
a memory configured to store working channel information indicating for each radio communication device of a plurality of radio communication devices information of at least one channel used by the respective radio communication device;
a radio communication device information receiver configured to receive working channel update information of at least one radio communication device of the plurality of radio communication devices. wherein the working channel update information indicates a channel that is intended to be used by the at least one radio communication device;
a conflict determination circuit configured to determine whether there is a conflict of channels to be used by the plurality of radio communication devices based on the working channel information and the working channel update information; and
a working channel information updating circuit configured to update the working channel information based on the determination of the conflict determination circuit.

2. The spectrum coordination device of claim 1,
wherein the radio communication device information receiver is further configured to receive location information of at least one radio communication device of the plurality of radio communication devices.

3. The spectrum coordination device of any one of claims 1 to 2, further comprising:
an interference relation determination circuit configured to determine an interference for a plurality of channels based on the location information.

4. The spectrum coordination device of claim 3,
wherein the interference relation determination circuit is configured to determine the interference for the plurality of channels further based on a radio propagation model.

5. The spectrum coordination device of any one of claims 1 to 4, further comprising:
a channel occupation information determination circuit configured to determine channel occupation information indicating for each radio communication device of the plurality of radio communication devices at least one of a load and a maximum transmission power for at least one channel.

6. The spectrum coordination device of any one of claims 1 to 5, further comprising:
a transmitter configured to transmit to each radio communication device of the plurality of radio communication devices the channel occupation list.

7. The spectrum coordination device of any one of claims 1 to 6,
wherein the working channel information updating circuit is configured to set the channels of a radio communication device that is to re-select new channels to a pre-determined value.

8. The spectrum coordination device of any one of claims 1 to 7,
wherein the working channel update information indicates a channel that is not yet used by the at least one radio communication device

9. A spectrum coordination method comprising:
storing working channel information indicating for each radio communication device of a plurality of radio communication devices information of at least one channel used by the respective radio communication device;
receiving working channel update information of at least one radio communication device of the plurality of radio communication devices, wherein the working channel update information indicates a channel that is intended to be used by the at least one radio communication device;
determining whether there is a conflict of channels to be used by the plurality of radio communication devices based on the working channel information and the working channel update information; and
updating the working channel information based on the determining whether there is a conflict.

10. The spectrum coordination method of claim 9, further comprising:
receiving location information of at least one radio communication device of the plurality of radio communication devices.

11. The spectrum coordination method of claim 9 or 10, further comprising:
determining an interference for a plurality of channels based on the location information.

12. The spectrum coordination method of claim 11, further comprising:
determining the interference for the plurality of channels further based on a radio propagation model.

13. The spectrum coordination method of any one of claims 9 to 12, further comprising:
determining channel occupation information indicating for each radio communication device of the plurality of radio communication devices at least one of a load and a maximum transmission power for at least one channel.

14. The spectrum coordination method of any one of claims 9 to 13, further comprising:
transmitting to each radio communication device of the plurality of radio communication devices the channel occupation list.

15. The spectrum coordination method of any one of claims 9 to 14, further comprising:
setting the channels of a radio communication device that is to re-select new channels to a pre-determined value.

16. The spectrum coordination method of any one of claims 9 to 15,
wherein the working channel update information indicates a channel that is not yet used by the at least one radio communication device

23. (canceled)

24. (canceled)

25. (canceled)
